(19) United States
(12) Patent Application Publication
(10) Pub. No.: US 2002/0115777 A1
(43) Pub. Date: Aug. 22, 2002

(54) Nanocomposites in powder coatings

(76) Inventors: Bin Wu, Marietta, GA (US); Zhikai Wang, Roswell, GA (US)

Correspondence Address: WENDEROTH, LIND & PONACK, L.L.P., 2033 K STREET N. W., SUITE 800, WASHINGTON, DC, 20006-1021, US

(21) Appl. No.: 09/736,130

(22) Filed: Dec. 15, 2000

(51) Int. Cl. C08K 3/34

(52) U.S. Cl. 524/445

(57) ABSTRACT

A powder coating composition comprising inorganic nanoparticles and a thermocurable or radiation curable resin. The nanoparticles impart a wide range of improved properties to the compositions such as hardness and abrasion resistance.

### BACKGROUND OF THE INVENTION

This invention relates to the utilization of nanoparticles in powder coating formulations to enhance various properties of the coatings.

Conventional powder coatings have many shortcomings in their process and application properties. For example, in order to obtain a good and smooth film, powders must flow well at cure temperature, and many powder coating systems do not flow well due to their high melt viscosity. One normal way to improve the flow is to use resin binders of low melt viscosity. However, low-viscosity resins usually also have low glass transition temperatures, which diminishes storage stability as sintering increases. A typical powder coating formulation must have a softening point higher than 40° C. to prevent sintering and maintain sufficient storage stability.

Conventional powder coatings also suffer from low surface hardness, as well as abrasion and stain resistance. These shortcomings prevent powder coatings from further penetrating into many applications areas of conventional solvent coatings.

The use of inorganic fillers to improve properties of coatings is well known. However, there are many limitations in using fillers. First of all, larger quantities of fillers must be used to obtain good results, and this can change other properties of powder coatings. For example, the melt viscosity can be increased dramatically. Secondly, it may be difficult to incorporate large quantities of filler into coating compositions desired by coating performances due to the difficulty of the dispersion process and dispersion stability problems, mainly because of the filler's incompatibility with organic resins and hardeners.

Nanoparticles discussed in the current invention are inorganic particles with diameters in the range of 1 to 100 nanometers. An inorganic nanoparticle can be, for example, clay-based. A clay particle can be chemically modified to be compatible with organic polymers by inserting or “intercalating” chemistry into the spaces or “galleries” between the clay surfaces. When the clay particles are fully dispersed in the host polymer, a state of “exfoliation” occurs. Due to the large surface area of nanoparticles, even small amounts can have an intimate interaction with the polymer, and change coating properties significantly. Therefore, nanoparticles can enhance many properties of powder coatings.

In the following reference: S. Sepeur, et al., Mater. Res. Soc. Symp. Proc., Vol., 576, (1999), a sol-gel process was described in which a hybrid of thermoset resin/SiO₂ nanoparticles was produced in situ. A pencil hardness of 4H was achieved. However, this process has the following disadvantages: 1) The synthesis of the resin requires a large portion of organo-silicon compounds, which increases raw material cost; 2) The method is not compatible with current powder coating manufacturers processes; 3) Hydrolytic stability of the coatings is a concern.

In U.S. Pat. Nos. 5,385,776, 5,514,734 and 5,747,560 nanocomposites employing thermoplastic resins, e.g. polyamides, polyolefins, vinyls, e.g. plasticized PVC, etc., are disclosed as useful in powder coating. However, thermoplastics based powder coating compositions have significant limitations as will now be discussed.

Disadvantages of Thermoplastic Based Powder Coatings

Powder coating types can be categorized into two broad divisions: thermoplastic and thermocurable. Thermoplastic powders do not chemically react during application or baking. Therefore, these materials will remelt after cooling when heat is applied. Due to their nature and application limits, thermoplastic powders are generally used only for functional coatings.

Unlike thermoplastic coatings, thermocurable powder coatings will chemically react during baking to form a polymer network which is more resistant to coating breakdown. Additionally thermocurable powder coatings will not remelt after cooling when heat is applied. Even though there is widespread use of functional powder coatings for protective purposes, the vast majority of powders are utilized in decorative applications where color, gloss, and appearance may be the primary attributes. That is why the powders used in the industry are predominantly thermocurable powder coatings.

Polyamide is a typical thermoplastic powder coating resin. Examples of the disadvantages of a thermoplastic powder coating system are:

High cost

High process temperatures

High viscosity

Poor adhesion to most substrates

a Low thermal stability

Not easy to achieve thin films

Process Limit—can only be applied by fluidized bed application equipment.

Only limited to functional coatings.

### SUMMARY OF THE INVENTION

Due to the nature of powder coatings and the characteristics of nanoparticles, there is great potential in using nanoparticles to enhance various properties of powder coatings. Therefore, the first object of the invention is to provide a composition, which incorporates certain types of nanoparticles for making powder coatings with high pencil hardness, in certain resins, i.e. thermocurable or radiation curable resins such as polyesters, epoxy, acrylics and vinyl functional resins such as vinyl esthers. Such resins and nanoparticles are employed in the other object applications set forth below.

The second object of the invention is to provide a composition, which incorporates certain types of nanoparticles for making powder coatings with high scratch resistance.

Another object of the invention is to provide a composition which incorporates a certain type of nanoparticles for making powder coatings of low viscosity and excellent flow-out property, which results in finished films of great smoothness and great distinctiveness of image (DOI).

Another object of the invention is to provide a composition, which incorporates certain types of nanoparticles for making powder coatings with high abrasion/wear resistance.

Another object of the invention is to provide a composition, which incorporates certain types of nanoparticles for making powders with high glass transition temperature and thus desirable storage stability.

Another object of the invention is to provide a composition, which incorporates certain types of nanoparticles for making powder coatings with high solvent/chemical resistance.

Another object of the invention is to provide a composition, which incorporates certain types of nanoparticles for making powder coatings with high impact resistance.

Another object of the invention is to provide a composition, which incorporates certain types of nanoparticles for making powder coatings with high barrier properties.

Another object of the invention is to provide a composition, which incorporates certain types of nanoparticles for making powder coatings with high fire retardancy and heat resistance.

Another object of the invention is to provide a composition, which incorporates certain types of nanoparticles for making powder coatings with high refractive index, transparency.

Another object of the invention is to provide a composition, which incorporates certain types of nanoparticles for making powder coatings with high stain resistance.

Another object of the invention is to provide a composition, which incorporates certain types of nanoparticles for making powder coatings with controllable gloss.

Another object of the invention is to provide a composition, which incorporates certain types of nanoparticles for making powder coatings with controllable surface tension.

Another object of the invention is to provide a composition, which incorporates certain types of nanoparticles for making powder coatings with controllable film permeability.

The powder coating compositions described above may be processed using conventional methods, e.g. premixing and extrusion. Powders may be applied onto various substrates such as metals, medium density fiber (MDF) board and wood, using conventional and unconventional methods. Examples of conventional application methods are electrostatic spray (Corona charging or Tribo charging), fluidized bed and flamespraying. Curing may be achieved by thermal heating, induction coating, infrared heating, ultraviolet (UV) and electron beam (EB) radiation.

Other objects of the present invention will become apparent to people skilled in the art from the description of the invention that follows and from the disclosed preferred embodiment thereof.

The present invention enables the aforementioned objects. Indeed, the invention provides compositions containing nanoparticles for powder coatings with improved properties. The nanoparticles used in the present invention may be untreated nanoparticles, nanoparticles with hydrophobic or hydrophilic functional groups on their surfaces, or nanoparticles with non-reactive or reactive groups on their surfaces. The nanoparticles used in this invention may be melt blended into a powder resin or melt extruded into a powder coating formulations.

The present powder coating systems are either of the thermocurable or radiation curable types.

### BRIEF DESCRIPTION OF THE DRAWING

FIG. 1 depicts the effect of nanoclay on resin viscosity;

FIG. 2 depicts the flow of a composition containing nanoclay vs. one which does not (control).

### DETAILED DESCRIPTION

A typical thermosetting powder coating formulation consists of the following ingredients:

Resin(s)

Crosslinker(s)

Pigments

Flow Agent

Degassing Agent

Curing Catalyst

Stabilizers

Other performance-enhancing additives. Typical resins are:

Polyesters

Epoxies

Acrylics

These resins are formulated with different crosslinkers (curatives or hardeners) for different application needs. The most commonly used crosslinkers are:

Amines

Epoxy resins

Triglycidyl isocyanurate (TGIC)

Carboxylic acids

Anhydrides

Blocked isocyanates

Melamines

Glyco-uril

Hydroxy alkylamide (e.g. Primid)

Non-blocked isocyanates

Another type of powder coating is the radiation-curable (e.g. UV and Electron Beam) system, which consists of one or more resins and photo initiators and other necessary ingredients as mentioned in thermosetting coating systems.

An example of radiation curable powder coating system contains an unsaturated polyester with a molecular weight in the range of 1,000 to 10,000, a photoinitiator and other ingredients typically used in a conventional powder coating formulation. An example of the unsaturated polyester is UCB Uvcoat 1000. Etc. An example of the photoinitiator is Ciba Irgacure 2959 or in combination with Irgacure 819.

The following summarizes the experimental procedures and the results obtained. It should be noted that the procedures and formulations only serve as examples of the invention. The scope of the invention is not be limited to these examples.

As a first embodiment of the invention, there are employed untreated, i.e. unfunctionalized inorganic nanoparticles. These typically are metal oxide nanoparticles such as aluminum oxide, titanium oxide, zirconium oxide and iron oxide, as well as aluminosilicates, e.g. nanoclays, which may be modified with various functional groups such as amines, carbonitrides, silicon nitrides, carbon and silica.

Such inorganic nanoparticles may then be incorporated in polymerized or resins (polymers) such as thermocurable resins, e.g. polyesters (saturated and unsaturated), polyepoxide and polyacrylates or polymethacrylates, in amounts of about 0.1% to 50%, based on the weight of the powder coating composition.

As a second embodiment of the invention, the above nanoparticles may be treated with reactive or polymerizable functional groups such as epoxy groups, vinyl groups, acrylates and methacrylates, etc.

Alternatively, the above nanoparticles may be treated with non-reactive functional materials such as hydrocarbons or may be treated by ion exchange.

Typically, the present compositions are prepared by melt blending or melt extrusion.

In melt blending, a resin-nanoparticle mixture is stirred at an elevated temperature.

In melt extrusion, all of the ingredients of a powder formulation including resin, hardener, pigment, catalyst and nanoparticles are admixed and extruded at elevated temperatures.

Materials

Nanomer 1.34 TCA, a nanoclay modified by an amine with long aliphatic substitutes, was obtained from Nanocor Corporation.

Aluminum Oxide C, an unmodified nanoparticle, was obtained from Degussa-Huls.

Crylcoat 370, an acid functional polyester powder resin produced by UCB Chemicals Corporation. Acid number (AN)=50 mg KOH/g

Crylcoat 3004, an acid functional polyester powder resin produced by UCB Chemicals Corporation. AN=70 mg KOH/g.

RX 01387, an epoxy functionalized Al_{2O}₃ nanoparticle.

Melt Blending

3556 g of Crylcoat 370 was transferred to a 10-liter round-bottom flask. The resin was heated to 200° C. until completely melted. The temperature was maintained at 200° C. while the molten resin was stirred. 53g of Nanomer I.34TCA was added into the flask. The resin and nanoparticle mixture was stirred at 200° C. for one hour before poured into an aluminum pan. The new resin is referred to as NE 2107.

Melt Extrusion

All ingredients of a powder formulation including the resin, hardener, pigment, degassing agent, catalyst and the nanoparticle were mixed in a Prism Pilot 3 High-Speed Premixer. Premix speed was 2000 RPM and total mixing time was 4 minutes. The premixed mixture was then extruded in a Prism 16 PC twin screw extruder at approximately 110° C. The extrudate was cooled at 30° C. for 24 hours. The cooled flakes were ground in a Brinkmann high-speed grinder, sieved with a 140-mesh sieve into the final powder. The powder was applied electrostatically onto aluminum, steel or MDF substrates. The panels were baked at temperatures between 160° C. and 200° C. for 20-40 minutes.

Property Test

Viscosity was measured on a Brookfield viscometer at different temperatures. The viscosity profile was generated by plotting the viscosity values against temperatures.

Inclined plate flow (IPF) test was conducted according to the Powder Coating Institute (PCI) Test Procedure #7.

Distinctness of image (DOI): The procedure is listed in Instruments for Research and Industry Application Data Sheet included with the Model GB 11-DOI Glow Box.

Pencil Hardness was measured according to ASTM D3363, Pencil Scratch Hardness was measured.

Scratch resistance was measured according to the description below.

One common method of assessing the scratch resistance of a coating is to rub 0000 grade steel wool across the coating surface. The following technique uses a standard weight hammer to apply the force between the steel wool and the coating, increasing the reproducibility between operators. Cloth (cheesecloth or felt is ideal) is attached to the curved face of a 32 ounce ball peen hammer. A piece of 0000 steel wool approximately one inch in diameter is placed on the coating surface to be tested. The cloth covered curved face of the hammer is placed directly on the steel wool and, with the handle of the hammer held as close to horizontal as practical and no downward pressure exerted, the hammer drawn back and forth across the coating. The cloth on the hammer face provides a grip between the hammer and steel wool. Consequently, the steel wool is rubbed across the coating surface with equal force along a path. The path length is typically several inches and each back and forth motion is counted as a cycle. Care is taken to secure the coated substrate firmly and to maintain the same path for each cycle. After a predetermined number of cycles are completed, the coating surface is examined for changes in appearance such as an increase in haze resulting from scratches in the surface. A number, usually 1 to 5, is then given to rank the scratch resistance, 1 has the lowest resistance and 5 the highest. Alternately, cycles are continued and counted until the first visible sign of a change in the appearance of the coating.

Results and Discussion

1. Flow Improvement

Flow improvement was confirmed by the following three facts:

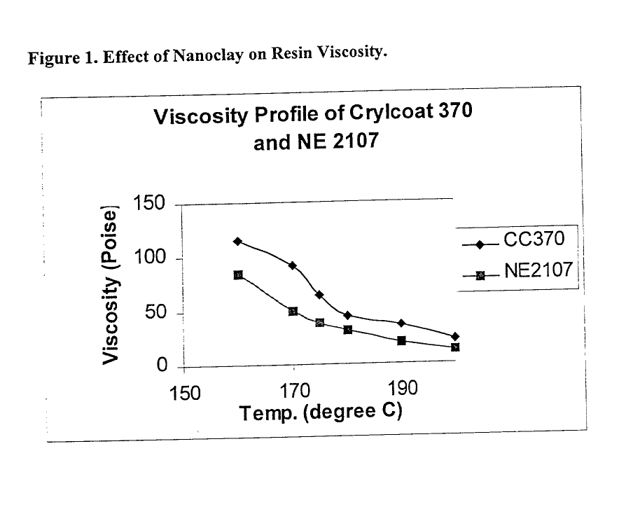

1) The powder resin containing nanoclay had lower melt viscosity. The viscosity profiles of resin Crylcoat 370 (control) and NE 2107 (containing 1.5% nanoclay) were shown in FIG. 1. As can be seen, on average the viscosity of NE 2107 is 30-40% lower that of Crylcoat 370.

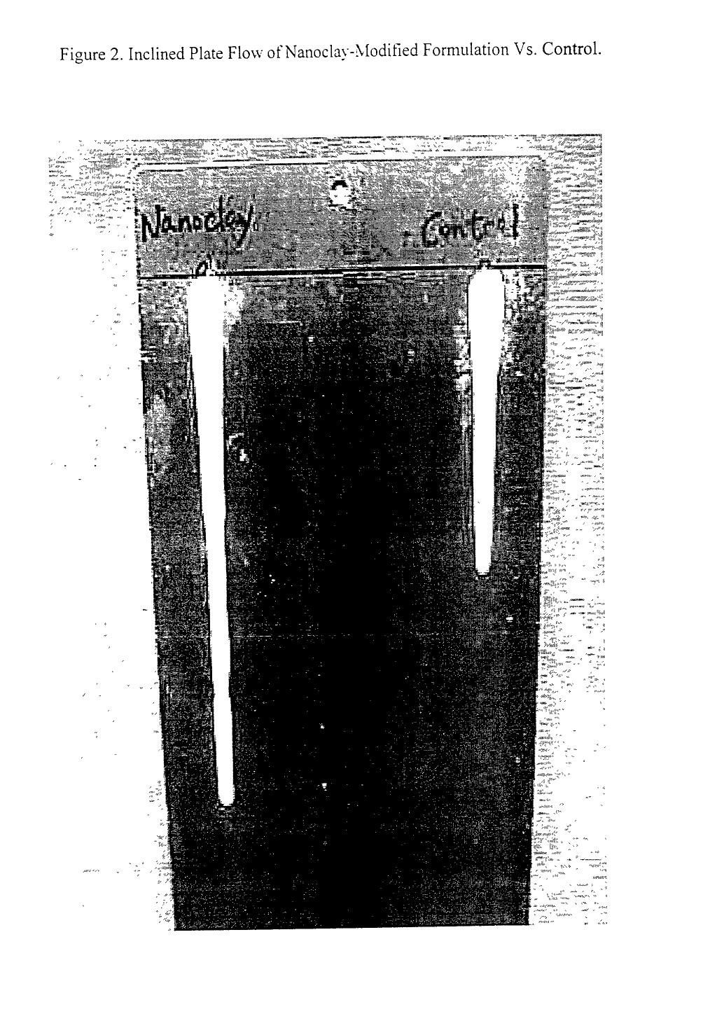

2) The powder based on NE 2107 had a much longer IPF. As can be seen in Figure 2 and Table 1, the IPF of NE 2107-based powder was 175 mm whereas Crylcoat based powder had an IPF of only 95 mm.

3) NE 2107 also exhibits better DOI than Crylcoat 370, as shown in Table 2.

1. Hardness Improvement

Formulations 1 through 5 are listed in Table 1. Coating properties of those formulations including hardness and scratch resistance can be found in Table 2. Comparing entry No. 3 with No. 1, it can be seen that the addition of 5% aluminum oxide C increased the pencil hardness of the coating from F to 3H and scratch resistance from 1 to 2. Similar improvement in hardness was observed with RX-01387 comparing the data of No. 4 and No. 5 in Table 2.

TABLE 1
Formulation of Powder Coatings

| | | | | | De- | |
|---|---|---|---|---|---|---|
| | Resin | Hardener | Nanoparticle | Flow- | gassing | Pigment |
| No. | Wt % | wt % | wt % | agent | agent | (TiO2) |
| 1 | CC 370 | EPON 2002 | — | | | |
| | 41.2 | 27.4 | — | 1.0 | 0.4 | 30.0 |
| 2 | NE 2107 | EPON 2002 | *Nanomer | | | |
| | | | I.34TCA | | | |
| | 41.2 | 27.4 | 0.6 | 1.0 | 0.4 | 30.0 |
| 3 | CC 370 | EPON 2002 | Al₂O₃ C | | | |
| | 41.2 | 27.4 | 5.0 | 1.0 | 0.4 | 25.0 |
| 4 | CC 3004 | EPON 2002 | — | | | |
| | 34.3 | 34.3 | — | 1.0 | 0.4 | 30.0 |
| 5 | CC 3004 | EPON 2002 | RX-01387 | | | |
| | 35.7 | 32.9 | 5.0 | 1.0 | 0.4 | 25.0 |

*I.34TCA was blended into the resin, see experimental part.

TABLE 2
Properties of the Powder Coatings

| Formulation | Gel Plate Flow | | | Scratch |
|---|---|---|---|---|
| No. | (mm) | DOI | Pencil Hardness | Resistance |
| 1 | 95 | 80 | F | 1 |
| 2 | 175 | 90 | H | 1 |
| 3 | — | — | 3 H | 2 |
| 4 | — | — | HB | 1 |
| 5 | — | — | 2 H | 1 |

We claim:

1. A powder coating composition comprising inorganic nanoparticles and a thermocurable or radiation curable resin.

2. The powder coating composition according to claim 1 wherein the nanoparticles are nanoclays.

3. The powder coating composition according to claim 1 wherein a mixture of resin and nanoparticles is melt extruded, cooled and is then subdivided to form the powder coating composition.

4. The powder coating composition according to claim 1 wherein the nanoparticles are blended with resin and the resultant mixture is melted, cooled and subdivided to form the powder coating composition.

5. The powder coating composition according to claim 1 wherein the resin is selected from the group consisting of saturated or unsaturated polyester resins, acrylic or methacrylic resins, epoxy resins, acrylate or methacrylate resins and vinyl functional resins.
